(19) United States
(12) Patent Application Publication
(10) Pub. No.: US 2018/0268373 A1
(43) Pub. Date: Sep. 20, 2018

(54) SYSTEM AND METHOD FOR DETERMINING KEY PROFESSIONAL SKILLS AND PERSONALITY TRAITS FOR A JOB

(71) Applicant: INTERNATIONAL BUSINESS MACHINES CORPORATION, ARMONK, NY (US)

(72) Inventors: Hari Bheemavarapu, Littleton, MA (US); Hemanth Kumar Choudhary Kadambala, Visakhapatnam (IN); Stefan Liesche, Boeblingen (DE); John Arthur Medicke, Raleigh, NC (US); Girish Padmanabhan, Pune (IN); Priya Rao, VISAKHAPATNAM (IN); Srikrishnan Sundararajan, BANGALORE (IN); Ravi Teja Vadlamani, Visakhapatnam (IN); Venkataramana Veeshagouni, Visakhapatnam (IN)

(73) Assignee: INTERNATIONAL BUSINESS MACHINES CORPORATION, ARMONK, NY (US)

(21) Appl. No.: 15/462,568

(22) Filed: Mar. 17, 2017

(51) Int. Cl. G06Q 10/10

(52) U.S. Cl. CPC G06Q 10/1053

(57) ABSTRACT

A method, system and computer program product for determining key professional skills and personality traits for a job is disclosed. A computer-implemented method is provided that comprises analyzing organization and industry data to identify one or more job-specific attributes associated with a job. A job-specific attributes profile for the job is generated comprising the one or more identified job-specific attributes. The job-specific attributes include one or more professional skills and personality traits that positively influence an outcome of the job.

### BACKGROUND

The present invention relates generally to the recruitment of job applicants, and more specifically, the process of finding, screening, and selecting the best-qualified candidate for a specific job, role or position in a company or organization.

### SUMMARY

The invention provided herein has a number of embodiments useful, for example, in identifying job-specific attributes, creating job descriptions, evaluating job interviews, and finding candidates suitable for a particular job. According to various embodiments of the present invention, systems, methods, and computer program products are provided for facilitating the recruitment of job applicants.

In one or more embodiments of the invention, a computer-implemented method for determining key professional skills and personality traits for a job is provided. The method comprises analyzing, on one or more computers, organization and industry data to identify one or more job-specific attributes associated with a job. A job-specific attributes profile comprising the one or more identified job-specific attributes is generated, on one or more computers, for the job. The job-specific attributes include one or more professional skills and personality traits that positively influence an outcome of the job.

In one or more other embodiment of the invention, a computer program product for determining key professional skills and personality traits for a job is provided. The computer program product comprises a computer readable storage medium having program instructions embodied therewith. The program instructions executable by a processor to cause the processor to analyze, on one or more computers, organization and industry data to identify one or more job-specific attributes associated with a job. The processor further generates, on one or more computers, a job-specific attributes profile for the job comprising the one or more identified job-specific attributes. The job-specific attributes include one or more professional skills and personality traits that positively influence an outcome of the job.

In one or more other embodiment of the invention, a system for determining key professional skills and personality traits for a job is provided. The system comprises a skill extractor executed by the computer. The skill extractor analyzes, on one or more computers, organization and industry data to identify one or more job-specific attributes associated with a job. The skill extractor further generates, on one or more computers, a job-specific attributes profile for the job comprising the one or more identified job-specific attributes. The job-specific attributes include one or more professional skills and personality traits that positively influence an outcome of the job.

### BRIEF DESCRIPTION OF THE DRAWINGS

Referring now to the drawings in which like reference numbers represent corresponding parts throughout:

FIG. 1 is a diagram illustrating an exemplary network data processing system that can be used to implement elements of the present invention;

FIG. 2 is a diagram illustrating an exemplary data processing system that can be used to implement elements of the present invention;

FIG. 3 is a diagram illustrating an exemplary data processing system that can be used to implement elements of the present invention;

FIG. 4 is a diagram illustrating exemplary process steps for extracting job-specific attributes, according to one or more embodiments of the present invention;

FIG. 5 is a diagram illustrating exemplary process steps for composing job description text based on extracted job-specific attributes, according to one or more embodiments of the present invention;

FIG. 6 is a diagram illustrating exemplary process steps for evaluating a job candidate interview, according to one or more embodiments of the present invention; and

FIG. 7 is a diagram illustrating exemplary process steps for matching a job candidate with a reference employee, according to one or more embodiments of the present invention.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

Typically, the biggest and most important asset for an organization is its workforce. Choosing the right talent for the different jobs, roles, positions available has a direct influence on the organization's operation and business. Thus, there are many stakeholders and people who do their bit in trying to pick the best or most qualified candidate for a specific job or position. These stakeholders may include, for example, recruiters, interviewers, hiring managers, and even automated systems that match the profile information of different candidates with specified job requirements. All of these stakeholders have the same goal of trying to map and match candidates' skills and abilities with the requirements of a job to determine the most suitable candidate. Embodiments of the present invention as described herein facilitate various aspects of the recruitment process, including identifying job-specific attributes desired in a candidate, creating job descriptions, evaluating job interviews, and finding candidates suitable for a particular job or position.

Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

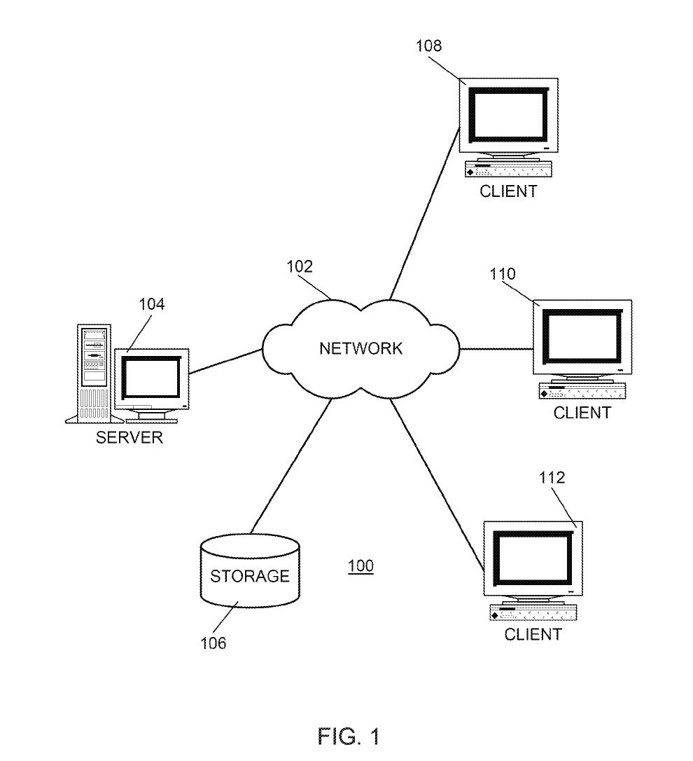

With reference now to FIG. 1, a pictorial representation of a network data processing system 100 is presented in which the present invention may be implemented. Network data processing system 100 contains a network 102, which is the medium used to provide communications links between various devices and computers connected together within network data processing system 100. Network 102 may include connections, such as wire, wireless communication links, or fiber optic cables etc.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and programs to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another.

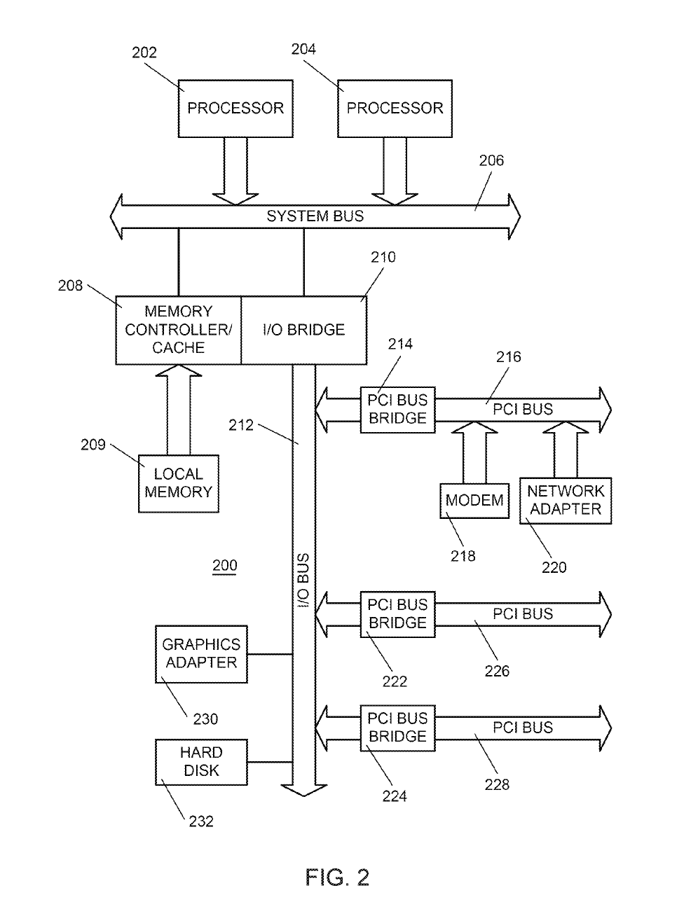

Referring to FIG. 2, a block diagram of a data processing system that may be implemented as a server, such as server 104 in FIG. 1, is depicted in accordance with an embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

Server 104 may provide a suitable website or other internet-based graphical user interface accessible by users to enable user interaction for aspects of an embodiment of the present invention. In one embodiment, Netscape web server, IBM Websphere Internet tools suite, an IBM DB2 for Linux, Unix and Windows (also referred to as “IBM DB2 for LUW”) platform and a Sybase database platform are used in conjunction with a Sun Solaris operating system platform. Additionally, components such as JBDC drivers, IBM connection pooling and IBM MQ series connection methods may be used to provide data access to several sources. The term webpage as it is used herein is not meant to limit the type of documents and programs that might be used to interact with the user. For example, a typical website might include, in addition to standard HTML documents, various forms, Java applets, JavaScript, active server pages (ASP), Java Server Pages (JSP), common gateway interface scripts (CGI), extensible markup language (XML), dynamic HTML, cascading style sheets (CSS), helper programs, plug-ins, and the like.

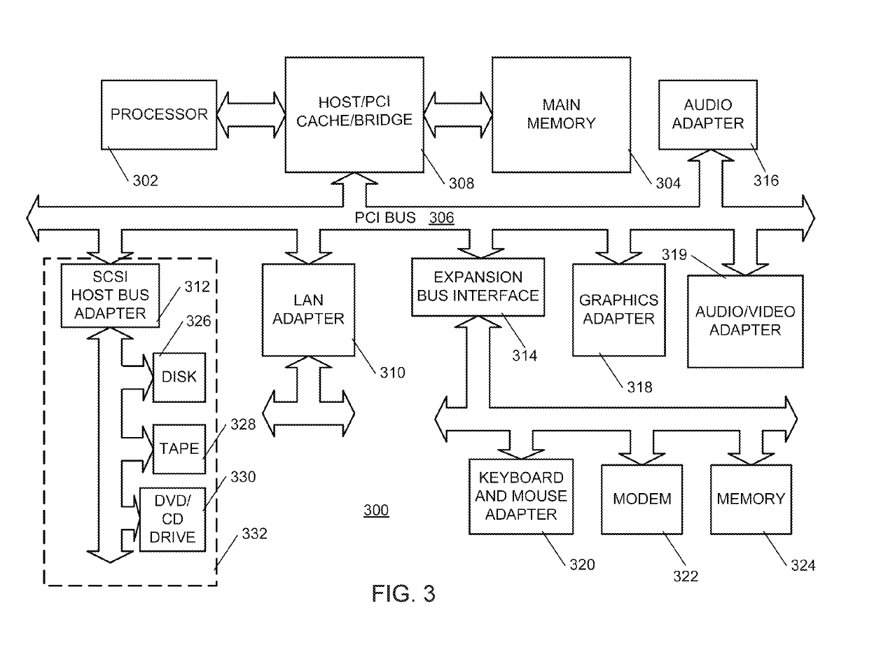

With reference now to FIG. 3, a block diagram illustrating a data processing system is depicted in which aspects of an embodiment of the invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots.

Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP®, which is available from Microsoft Corporation. An object oriented programming system such as Java may run in conjunction with the operating system and provide calls to the operating system from Java programs or programs executing on data processing system 300. “Java” is a trademark of Sun Microsystems, Inc. Instructions for the operating system, the object-oriented operating system, and programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer as well as a PDA. Further, data processing system 300 may also be a kiosk or a Web appliance. Further, the present invention may reside on any data storage medium (i.e., floppy disk, compact disk, hard disk, tape, ROM, RAM, etc.) used by a computer system. (The terms “computer,” “system,” “computer system,” and “data processing system” and are used interchangeably herein.)

Those skilled in the art will recognize many modifications may be made to this configuration without departing from the scope of the present invention. Specifically, those skilled in the art will recognize that any combination of the above components, or any number of different components, including computer programs, peripherals, and other devices, may be used to implement the present invention, so long as similar functions are performed thereby.

For example, any type of computer, such as a mainframe, minicomputer, or personal computer, could be used with and for embodiments of the present invention. In addition, many types of applications other than caching applications could benefit from the present invention. Specifically, any application that performs remote access may benefit from the present invention.

Herein, the term “by” should be understood to be inclusive. That is, when reference is made to performing A by performing X and Y, it should be understood this may include performing A by performing X, Y and Z.

Identifying Job-Specific Attributes

According to one aspect of the present invention, a system, method, and/or computer program product identifies and extracts the appropriate employee skills and traits needed for a specific job, position or role in a specific organization or industry using various organization and industry data and workforce sciences input. Typically, the biggest and most important asset for an organization is its workforce. Choosing the right talent for the different jobs, roles, positions available has a direct influence on the organization's operation and business. Thus, there are many stakeholders and people who do their bit in trying to pick the best candidate for a specific job or position. These stakeholders may include, for example, recruiters, interviewers, hiring managers, and even automated systems that match the profile information of different candidates with specified job requirements. All of these stakeholders have the same goal of trying to map and match candidates' skills and abilities with the requirements of a job to determine the most suitable candidate.

However, even assuming that the stakeholders are doing their best in matching efficiently and selecting the most suitable candidates, studies have found that a large number of organizations have indicated that they would not rehire 39% of their recent hires for the same roles (Source: Smarter Workforce Institute, IBM). This shows that something else, a critical factor, is missing in the current process of hiring talent. A major issue is that all of these matchings/mappings are based on a determination of whether a candidate has the “required skills” for a job. But there is often no clear definition on what are the required skills and abilities for a candidate to be successful at a specific job in a specific organization or industry. In addition to professional skills and qualifications, the “required skills” for a job or position may include other character or personality traits of the candidate that are not easily determined.

Embodiments of the present invention bring in job-specific attributes (such as professional skills and personality traits) and workforce sciences input to generate job-specific attributes profiles that provide the “required skills” for specific jobs and positions. This complex yet efficient and accurate method runs through volumes of organization and industry data (such as historic human resources data) related to different jobs, roles, and positions. The systems and methods provided herein simplify the recruitment and hiring process by recommending, in certain embodiments, the most appropriate set of skills, traits and their values/proficiency levels for a specific job. It also allows the stakeholders to be more efficient and accurate when making decisions on job candidates. Altogether, this can greatly influence the operation, revenue etc. of the underlying business or organization.

In one or more embodiments, a system, a method, and/or a computer program product for determining key professional skills and personality traits for a job is provided. Organization and industry data is analyzed to identify one or more job-specific attributes associated with a job, role or position. A job-specific attributes profile comprising the one or more identified job-specific attributes is generated for the job. The job-specific attributes include one or more professional skills and personality traits that positively influence an outcome of the job. In typical embodiments, a job-specific attributes database is created having a plurality of job-specific attributes profiles, wherein each job-specific attributes profile is associated with a different job, role or position.

In one or more embodiments, the organization and industry data is historic human resources (HR) data from a database or a human resources information system (HRIS) regarding all aspects of recruitment and employment (e.g. talent acquisition, assessments, onboarding, engagement) for different jobs, positions, and roles. The organization and industry data may include, for example, hiring data, onboarding data, online profiles and other user authorized data from the Internet, resume information, assessments data, and job performance data.

A skill extractor is used to analyze the organization and industry data. Generally, the skill extractor churns through the organization and industry data, analyzing and identifying various key skills and traits that are available from previous hires for a job or position. Such key skills include any professional skills, abilities or qualifications that have had an influence in the performance of the previous hire for the specific job. Professional skills include, for example, management experience, strategy creation, subject or domain knowledge, degrees and certificates, technical expertise, problem solving skill, teamworking ability, customer relationship, negotiation skill or communication skill. Additionally, with data such as the communication, commentary, and behavioral assessment results that is available for previous hires, the skill extractor also identifies and extracts personality traits or other variables that have also had an influence in the performance of the previous hire for the specific job, influenced the possibility of the previous hire accepting the offer/joining, ability to fit the culture of the organization, etc. Personality traits include, for example, numerical reasoning, communication, self-motivation, and emotional range.

The skill extractor uses an artificial intelligence or machine learning engine to identify or auto-extract the various skills and traits that are available (including their context, relevance, relation and broader meaning). The skill extractor engine performs various operations, such as natural language processing, relationship extraction, database retrieval and ranking, and personality insights on the organization and industry data to identify relevant attributes for a job. Preferably, the skill extractor engine is sophisticated enough to make determinations not only by the keywords, but also infer a broader context/meaning of the keywords. For example, with the information that a previous hire “graduated from the Massachusetts Institute of Technology (MIT)”, the skill extractor engine does not simply consider “Massachusetts Institute of Technology (MIT)” in isolation, but rather infers a broader context that the previous hire “graduated from one of the world's top 10 universities”. Furthermore, each identified attribute includes metadata comprising, for example, keyword(s), entity, relation, context, sentiment, importance, eminence, relevance, proficiency level, and broader meaning. The system builds a data-store with all the metadata around the job-specific attributes identified (for their importance and eminence). The metadata (e.g. keywords, entities, context and relation between them) serve as variables in an analytics based model.

From the attributes identified for a job, the skill extractor is able to deduce which ones have influenced positive outcomes with the previous hire. Positive outcomes include, for example, acceptance of the job, positive performance at the job, cultural fit at the organization providing the job, or employer satisfaction of an employee at the job. This list of positive attributes is specific to a certain job of a certain organization in a certain industry. The identified job-specific attributes generally include one or more professional skills and personality traits that positively influence an outcome of the job. A job-specific attributes profile comprising the one or more identified job-specific attributes is generated for the job.

In certain embodiments, all of these positive job-specific attributes are validated and combined with workforce sciences input to form the job-specific attributes profile. Workforce sciences input include, for example, industrial or organizational psychologist recommendations and data and behavioral science recommendations. Overall, historic organization and industry data, data from public domain, and sciences are applied to extract an accurate skills and traits list or job-specific attributes profile, which is the crux of identifying the right talent for a specific job.

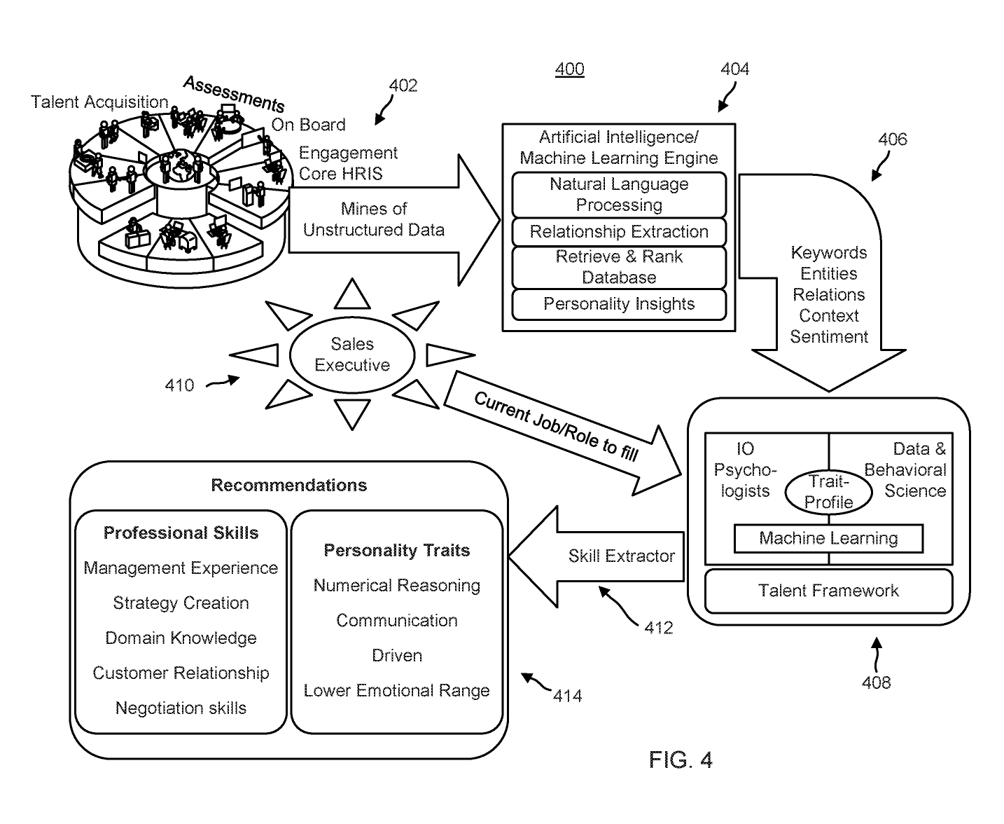

FIG. 4 is a diagram illustrating exemplary process steps 400 performed by the network data processing system 100 for extracting job-specific attributes, according to one or more embodiments of the present invention. Organization and industry data relating to past or current employees of a company, which includes information obtained from talent acquisition, assessments, onboarding, employee engagement, and core human resources information systems, is provided as mines of unstructured data 402 stored on the server 104. An artificial intelligence/machine learning engine 404 performed by the server 104 uses processes such as natural language processing, relationship extraction, database retrieval and ranking, and personality insights to analyze the organization and industry data and identify attributes (e.g. professional skills and personality traits) associated with different jobs. These job-specific attributes include metadata 406 stored on the server 104 such as keywords, entities, relations, context, and sentiment. Workforce sciences input from industrial or organizational (10) psychologists and data and behavioral science are combined with the job-specific attributes. Using trait profiles and machine learning techniques, a job-specific attributes database or talent framework 408 is created on the server 104 comprising the key professional skills and personality traits needed for specific jobs, roles and positions in the company. The key skills and traits for each job, role or position is organized as individual job-specific attribute profiles.

In this illustrative example, a sales executive position 410 needs to be filled. Based on the job/role to be filled, a skill extractor 412 performed by the server 104 uses the job-specific attributes database 408 stored on the server 104 to provide recommendations 414 comprising a job-specific attribute profile for the sales executive position 410 to a client 108, 110, or 112. Here, the recommendations 414 comprising a job-specific attribute profile recommends that key professional skills for a sales executive are management experience, strategy creation, domain knowledge, customer relationship, and negotiation skills. In addition, the recommendations 414 comprising a job-specific attribute profile recommends that key personality traits for a sales executive are numerical reasoning, communication, driven, and lower emotional range.

Composing Job Description Text Based on Extracted Job Specific Attributes

According to another aspect of the present invention, the system, method, and/or computer program product suggests the most appropriate job description text with the skills and traits desired for a specific job. This job description text is based on the job-specific attributes profile described herein. As described above, an organization's biggest and most important asset is typically its workforce. Selecting the right talent for the jobs and roles available has a direct influence on the organization's business and operations. This task is predominantly initiated and handled by human resources personnel. The entire selection process and technologies heavily rely and revolve around the job description and the skills listed as job requirements.

However, be it the human resources personnel or domain experts, when it comes to selecting human beings for jobs, the intricacies of the recruitment process are so complex that most of the time instincts and luck end up playing a major role in a hiring decision. The finding noted previously that organizations are hesitant to rehire 39% of their recent hires for the same roles indicates that the quality of current hiring practices is still very poor. The job postings and descriptions that are created and listed for a job often capture inadequate and sometimes inappropriate information. Since the entire hiring process, including the job posting, search, interview, and selection, relies on these job descriptions and skill requirement lists, the limitations in providing an appropriate description of the key skills required for a job is one of the biggest culprits in producing bad hires. Current automated screening methods rely on resume parsing. However, due to their limited nature, current automated screening methods have been reported to be have inaccuracies of up to 75% in some cases, wasting a lot of time, resources, productivity, effort and later business/revenues (resulting from inappropriate hires).

Embodiments of the present invention recommend an appropriate job description covering multiple dimensions or attributes (e.g. professional skills, personality traits, academic requirements) based on a job-specific attributes profile for a job or position. As detailed above, the job-specific attributes profile is generated using organization and industry data (such as historic performance data of past/current employees) and workforce sciences input. These job-specific attributes, covering multiple aspects or dimensions of a person, are preferably specific to an industry, organization, job, and other demographic details. Based on the job-specific attributes profile, appropriate keywords, skills, and traits are recommended that may be looked up by job seekers, automatic job crawling systems, job boards, etc. Providing the appropriate job requirement and description content greatly helps match talent with the right or appropriate job. In addition to its use by the human resources personnel of companies and organizations, the present invention can also be used in industries such as staffing services under a pay-per-use model.

In one or more embodiments, a stakeholder such as a hiring manager requests a job description text for a particular job, position or role in the company. A job description text is generated based on the prebuilt job-specific attributes profile that is associated or mapped to the job. The job description text may also be further modified or enhanced by the hiring manager before being posted publicly. For example, the latest skills, traits, and requirements desired in a candidate for the job may be added.

Such systems and methods provide the benefits of a multidimensional approach that incorporates job-specific attributes such as professional skills and personality traits with workforce sciences input to build an accurate and appropriate job description. The recommended job description text is insightful and accurate since it considers historic data relating to successful employees and input from various workforce sciences. This improves hiring quality drastically, which directly affects the return on investment (ROI) of the underlying organization.

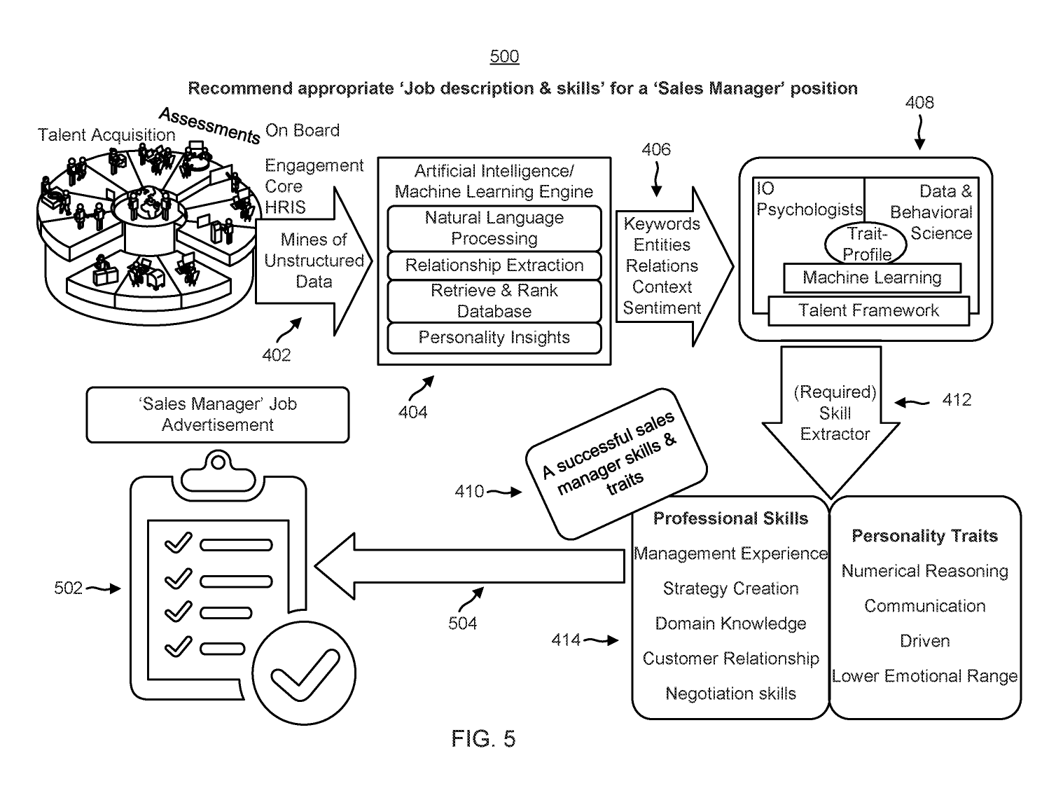

FIG. 5 is a diagram illustrating exemplary process steps 500 for composing job description text based on extracted job specific attributes, according to one or more embodiments of the present invention. Similar to FIG. 4 above, organization and industry data relating to past or current employees of a company, which includes information obtained from talent acquisition, assessments, onboarding, employee engagement, and core human resources information systems, is provided as mines of unstructured data 402 stored on the server 104. The artificial intelligence/machine learning engine 404 performed by the server 104 uses processes such as natural language processing, relationship extraction, database retrieval and ranking, and personality insights to analyze the organization and industry data and identify attributes (e.g. professional skills and personality traits) associated with different jobs. These job-specific attributes include metadata 406 stored on the server 104 such as keywords, entities, relations, context, and sentiment. Workforce sciences input from industrial or organizational (10) psychologists and data and behavioral science are combined with the job-specific attributes. Using trait profiles and machine learning techniques, the job-specific attributes database or talent framework 408 is created on the server 104 comprising the key professional skills and personality traits needed for specific jobs, roles and positions in the company. The key skills and traits for each job, role or position is organized as individual job-specific attribute profiles.

In this illustrative example, a sales manager position 410 needs to be filled. The skill extractor 412 performed by the server 104 uses the job-specific attributes database 408 stored on the server 104 to provide recommendations 414 comprising a job-specific attributes profile for the sales manager position 410 to a client 108, 110, or 112. Here, the recommendations 414 comprising a job-specific attributes profile recommends that key professional skills for a successful sales manager are management experience, strategy creation, domain knowledge, customer relationship, and negotiation skills. In addition, the recommendations 414 comprising a job-specific attributes profile recommends that key personality traits for a sales manager are numerical reasoning, communication, driven, and lower emotional range. From the recommendations 414 comprising a job-specific attributes profile, a job description text 502 for a sales manager is generated 504 by the server 104. Human resources can then use this job description text 502 in creating a job advertisement or posting that will be able to accurately describe the desired skills and traits sought in a candidate for the sales manager position at the company.

Evaluating Job Candidate Interview

According to another aspect of the present invention, the system, method, and/or computer program product identifies and evaluates an interview process (including the interviewer and interview questions) based on the relevant skills and traits extracted from the candidate. The system and method uses historic data and artificial intelligence capabilities. As described above, an organization's biggest and most important asset is typically its workforce. Selecting the right talent for the jobs and roles available has a direct influence on the organization's business and operations. The backbone of this selection process is the interview process. Interviewing has become a great science, art, and a critical skill in itself. An efficient and effective interview has many aspects in it, such as the time taken and the information obtained. The interviewer's own skills and experience also greatly influence their interviewing skills, for example, influencing the kind of questions they ask.

However, it often takes much time and effort for an interviewer to prepare for an interview. A lot of information and guidelines are available with regards to conducting interviews, with most suggesting that effective interview questions should be open-ended. But often the wrong candidate is still selected, due to the guidelines not being followed or simply due to the lack of interviewing skills of the interviewer. In some situations, despite an interviewer's best efforts, the questions used in the interview might not be the most effective ones. Effective questions are those that provide the interviewer with a better idea of whether a candidate has the desired and relevant skills and traits suitable for a specific job, position or role in a specific industry or organization.

Embodiments of the present invention evaluate the various aspects of an interview process, including the interviewer and/or interview questions. As detailed above, a job-specific attributes profile is generated using historic organization and industry data and workforce sciences input. The organization and industry data may include various data sources such as resumes, cover letters, online contributions, communication data, assessments, industry standards, and historical data of successful past or current employees. Using this data, the generated job-specific attributes profile provides the required and appropriate skills and traits for a specific job. From current and historic interview questions, candidate responses and past employee outcomes, the system determines what skills or traits can be inferred and whether these skills or traits match those of the job-specific attributes profile for the particular job. Preferably, the system is also able to recommend an appropriate set of open-ended interview questions depending on the industry, organization, job, role or candidate. In certain embodiments, the system is able to determine from the organization and industry data if a specific interview question played a role in selecting a candidate who later became successful hired employee. The system can also note any interview questions that were ineffective and/or time-consuming. In other embodiments, the system further helps in analyzing the interviewing skills and capabilities of the interviewer.

In one or more embodiments, candidate-specific attributes (e.g. professional skills and personality traits) of a job candidate are identified using one or more interview questions. The candidate-specific attributes of the job candidate are compared with the j ob-specific attributes provided in the job-specific attributes profile for the job. The qualification or suitability of the candidate may be determined depending on how closely the candidate-specific attributes match the job-specific attributes profile.

In some embodiments, the interview questions are evaluated for their effectiveness in obtaining pertinent information about the candidate for a specific job, position or role. The candidate-specific attributes of the candidate that are identified are compared with the job-specific attributes provided in the job-specific attributes profile to determine if the interview questions used were effective in identifying the same skills and traits as those provided in the job-specific attributes profile (i.e. the skills and traits required for the job). The interview questions may be current questions or also include historic interview questions used in past interviews. Historic interview questions and the outcomes of the people interviewed provide valuable information in evaluating the relevancy of the skills and traits obtained through these questions. In other embodiments, the interviewer is evaluated based on the interview questions. The interviewer's interviewing skills and capability is evaluated by analyzing the questions asked and their relevance in the given context. Effective interviewers are able to obtain all the desired and key information from a candidate by asking the right questions in a brief interview.

In another embodiment, the system generates interview questions to obtain information from a candidate related to the job-specific attributes associated with the job. Preferably, open-ended interview questions are recommended that target the specific skills and traits for a job as provided in the job-specific attributes profile. Such systems and methods provide the benefits of determining the right or optimal set of interview questions to be used when deciding on a candidate. By recommending an appropriate set of interview questions, a significant amount of time can be saved for the interviewer and candidate. It also helps a company or business evaluate its interview process by analyzing the interview questions and the interviewer's interviewing skills and capabilities.

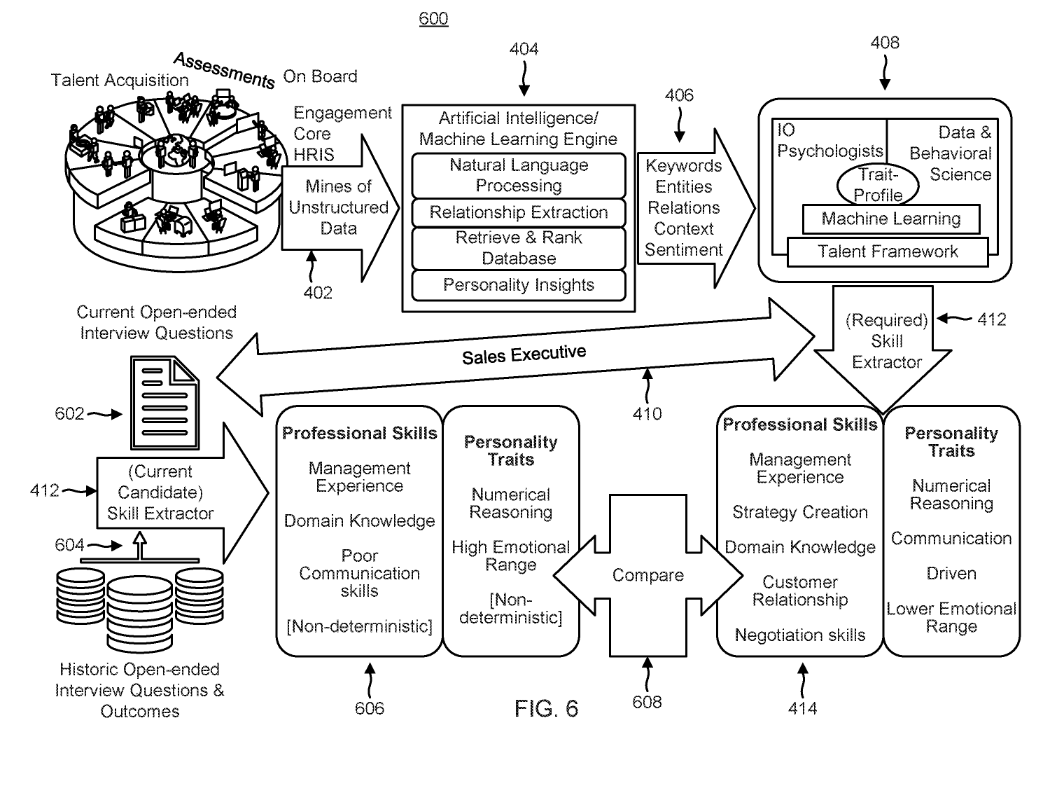

FIG. 6 is a diagram illustrating exemplary process steps 600 for evaluating a job candidate interview, according to one or more embodiments of the present invention. Similar to FIG. 4 above, organization and industry data relating to past or current employees of a company, which includes information obtained from talent acquisition, assessments, onboarding, employee engagement, and core human resources information systems, is provided as mines of unstructured data 402 stored on the server 104. The artificial intelligence/machine learning engine 404 performed by the server 104 uses processes such as natural language processing, relationship extraction, database retrieval and ranking, and personality insights to analyze the organization and industry data and identify attributes (e.g. professional skills and personality traits) associated with different jobs. These job-specific attributes include metadata 406 stored on the server 104 such as keywords, entities, relations, context, and sentiment. Workforce sciences input from industrial or organizational (10) psychologists and data and behavioral science are combined with the job-specific attributes. Using trait profiles and machine learning techniques, the job-specific attributes database or talent framework 408 is created on the server 104 comprising the key professional skills and personality traits needed for specific jobs, roles and positions in the company. The key skills and traits for each job, role or position is organized as individual job-specific attribute profiles.

In this illustrative example, a sales executive position 410 needs to be filled. The skill extractor 412 performed by the server 104 uses the job-specific attributes database 408 stored on the server 104 to provide recommendations 414 comprising a job-specific attributes profile for the sales executive position 410 to a client 108, 110, or 112. Here, the recommendations 414 comprising a job-specific attributes profile recommends that key professional skills for a sales executive are management experience, strategy creation, domain knowledge, customer relationship, and negotiation skills. In addition, the recommendations 414 comprising a job-specific attributes profile also recommend that key personality traits for a sales executive are numerical reasoning, communication, driven, and lower emotional range.

An interview is conducted with a job candidate for the sales executive position. During the interview, the current candidate is asked open-ended interview questions 602. The candidate's responses, as well as information from historical open-ended interview questions, past candidate responses, and their outcomes are stored 602 on the server 104. The skill extractor 412 performed by the server 104 uses the data 602 to identify and extract the candidate-specific attributes 606 of the current candidate. The candidate-specific attributes 606 include any existing professional skills and personality traits of the candidate relevant to the job. The candidate-specific attributes 606 are compared 608 by the server 104 with the recommendations 414 comprising a job-specific attributes profile previously identified for a sales executive position (management experience, numerical reasoning, etc.) as well as the candidate's proficiency level for these attributes. Here, the candidate-specific attributes 606 comprise the candidate's professional skills, which include management experience and domain knowledge, but also poor communication skills as well as other non-deterministic professional skills. The candidate-specific attributes 606 also comprise the candidate's personality traits, which include numerical reasoning, but also high emotional range as well as other non-deterministic personality traits. With this information from the candidate-specific attributes 606, the interviewer can make an informed decision on whether the candidate will be suitable for the sales executive position.

Matching Job Candidate with Reference Employee

According to another aspect of the present invention, the system, method, and/or computer program product matches a job seeking candidate with one or more existing or past employees of the organization based on multiple aspects of the job-specific attributes profile. Humans are generally more comfortable with people they already know or are familiar with. Thus, by drawing comparisons between a new candidate and a familiar or reference person, a more accurate and appropriate decision may be made on whether to the hire the candidate.

Embodiments of the present invention draw comparisons between existing or past employees and a new incoming candidate on multiple dimensions. A job-specific attributes database comprising job-specific attributes profiles for different jobs, roles and positions is generated using historic organization and industry data and workforce sciences input. Current and/or past employees of the company or organization are analyzed to identify their employee-specific attributes (such as professional skills and personality traits) that match the job-specific attributes profile for their respective jobs. The job-specific attributes profile is generated using organization and industry data and workforce sciences input and thus provides the key attributes for a specific job, role or position. Therefore, by identifying the attributes of employees based on the job-specific attributes profile, the company or organization is provided with the best overview of the relevant skills and traits for each employee. The employees are then organized and mapped to the job-specific attributes database depending on their job relevant attributes. The candidate-specific attributes of a job candidate are identified by analyzing information such as the candidate's profile/resume, cover letter, assessments, communication, other accessible contributions like blogs, social media content, papers etc., interview performance, and response to interview questions. The job candidate is then matched with one or more employees with similar attributes. The system maps the candidate to clusters/groups of similar employees based on similar skills and traits and provides information on whether the candidate would be the right fit for a certain job, role, position, team, organization etc. The system may also draw comparisons between candidates and employees based on automatically drawn insights from historic organization and industry data that pertain to various aspects such as professional skills, academic and other performances, personality insights, past employment data, and job performance. In other embodiments, the system further enables stakeholders to search for candidates who are similar to a specific reference employee or have a desired set of attributes.

In one or more embodiments, an employee is analyzed to identify one or more employee-specific attributes relating to the job-specific attributes in the job-specific attributes profile. In some instances, multiple employees are analyzed to identify the professional skills or personality traits for each employee. A database may be created comprising the employee-specific attributes for a number of or all of the past or current employees of a company or organization. A job candidate is matched with an employee based on the one or more employee-specific attributes. As described above, the job candidate is analyzed to identify candidate-specific attributes that include the professional skills and/or personality traits of the candidate. The employee database is searched to determine one or more similar employees with employee-specific attributes similar to the candidate-specific attributes of the job candidate.

In some embodiments, the systems and methods indicate the skills and traits or candidate-specific attributes that are inferior or superior to the skills and traits or employee-specific attributes of the matched employee(s). In other embodiments, the systems and methods recommend the job or position of the matched employee as a suitable job for the candidate. In another embodiment, a database of candidates and their respective candidate-specific attributes is generated. This database may be searched for a candidate with candidate-specific attributes most similar to a specific employee.

Such systems and methods provide the benefits of allowing a stakeholder to make an informed decision on the job candidate based on the similarities and differences of attributes between the candidate and matched employees. The recruitment process (e.g. hiring selection) is made much easier by comparing candidates with known and familiar employees based on specific job relevant attributes and understanding how the candidate is inferior or superior in these attributes. Based on the employee's job performance, the stakeholder has a good idea of the likely performance of the candidate at the same job. Thus, stakeholders have a much easier and simpler time finding the appropriate candidate for a job or the appropriate job for a candidate.

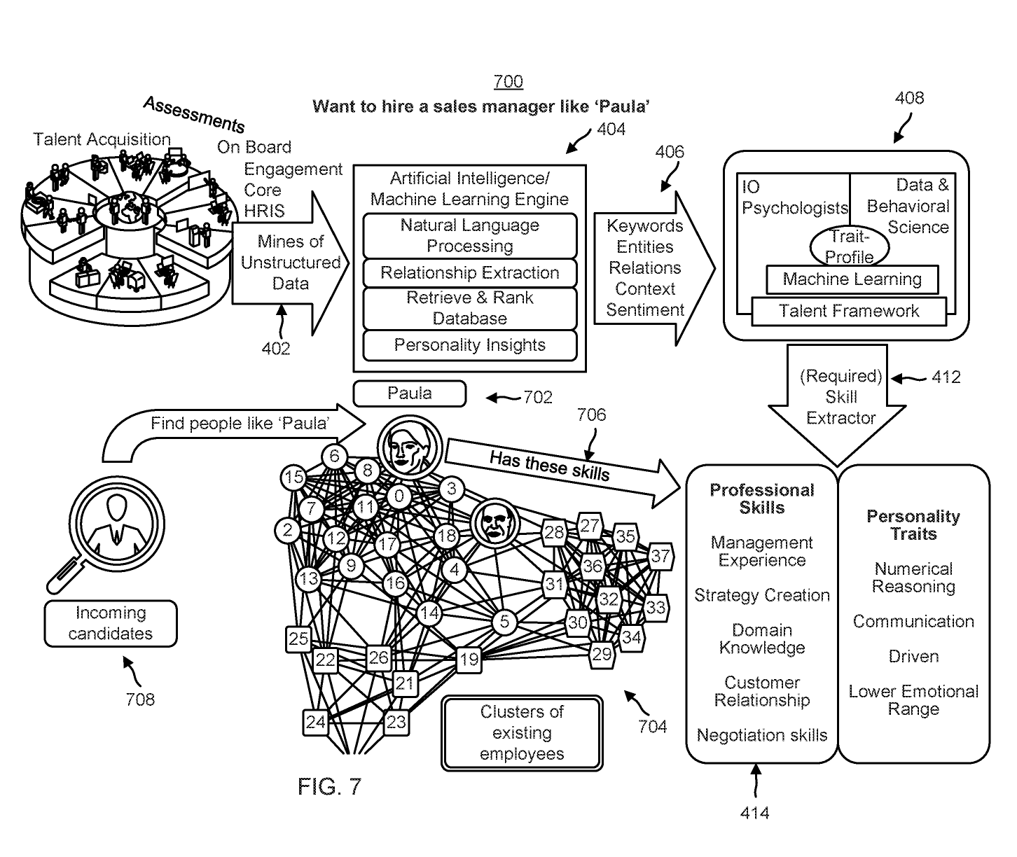

FIG. 7 is a diagram illustrating exemplary process steps 700 for matching a job candidate with reference employee, according to one or more embodiments of the present invention. Similar to FIG. 4 above, organization and industry data relating to past or current employees of a company, which includes information obtained from talent acquisition, assessments, onboarding, employee engagement, and core human resources information systems, is provided as mines of unstructured data 402 stored on the server 104. In this illustrative example, a company has decided that it wants to hire a sales manager similar to a reference employee, Paula 702. The artificial intelligence/machine learning engine 404 performed by the server 104 uses processes such as natural language processing, relationship extraction, database retrieval and ranking, and personality insights to analyze the organization and industry data and identify attributes (e.g. professional skills and personality traits) associated with Paula 702. These job-specific attributes include metadata 406 stored on the server 104 such as keywords, entities, relations, context, and sentiment. Workforce sciences input from industrial or organizational (IO) psychologists and data and behavioral science are combined with the job-specific attributes. Using trait profiles and machine learning techniques, a job-specific attributes database or talent framework 408 is created on the server 104 comprising the key professional skills and personality traits that are similar to Paula 702, wherein the key skills and traits are organized as individual job-specific attribute profiles.

The skill extractor 412 performed by the server 104 uses the job-specific attributes database 408 stored on the server 104 to provide recommendations 414 comprising a job-specific attributes profile for a sales manager like Paula 702 to a client 108, 110, or 112. All the existing employees of the company are organized in clusters 704 stored on the server 104 based on their skills and traits in relation to their respective job, role or position in the company, and are analyzed 706 by the server 104 to identify one or more candidates that share the same or similar attributes as Paula 702. In addition, incoming candidates 708 are analyzed (for example by their resumes/cover letters and interviews) by the server 104 to identify one or more candidates that share the same or similar attributes as Paula 702. By finding a candidate that is similar to Paula 702, there is a strong likelihood that the candidate will be able to perform similarly as Paula 702 in the sales manager position.

### CONCLUSION

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

What is claimed is:

1. A computer-implemented method for determining key professional skills and personality traits for a job comprising:
analyzing, on one or more computers, organization and industry data to identify one or more job-specific attributes associated with a job; and
generating, on one or more computers, a job-specific attributes profile for the job comprising the one or more identified job-specific attributes;
wherein the job-specific attributes include one or more professional skills and personality traits that positively influence an outcome of the job.

2. The computer-implemented method of claim 1, wherein generating the j ob-specific attributes profile for the job includes incorporating a workforce sciences input, wherein the workforce sciences input is an industrial or organizational psychology recommendation or a data and behavioral science recommendation.

3. The computer-implemented method of claim 1 further comprising creating a job-specific attributes database having a plurality of job-specific attributes profiles, wherein each job-specific attributes profile is associated with a different job.

4. The computer-implemented method of claim 1 further comprising generating a job description text based on the job-specific attributes profile for the job.

5. The computer-implemented method of claim 1 further comprising:
identifying one or more candidate-specific attributes of a job candidate using one or more interview questions; and
comparing the one or more candidate-specific attributes with the job-specific attributes profile.

6. The computer-implemented method of claim 5 further comprising evaluating an interview question, interviewer or interview process based on the candidate-specific attributes identified in comparison to the job-specific attributes in the job-specific attributes profile.

7. The computer-implemented method of claim 5 further comprising generating one or more open-ended interview questions designed to obtain information from the job candidate relating to the job-specific attributes in the job-specific attributes profile.

8. The computer-implemented method of claim 1 further comprising:
analyzing a reference employee to identify one or more employee-specific attributes relating to the job-specific attributes in the job-specific attributes profile; and
matching a job candidate with the reference employee based on the one or more employee-specific attributes.

9. A computer program product for determining key professional skills and personality traits for a job, the computer program product comprising a computer readable storage medium having program instructions embodied therewith, the program instructions executable by a processor to cause the processor to:
analyze, on one or more computers, organization and industry data to identify one or more job-specific attributes associated with a job; and
generate, on one or more computers, a job-specific attributes profile for the job comprising the one or more identified job-specific attributes;
wherein the job-specific attributes include one or more professional skills and personality traits that positively influence an outcome of the job.

10. The computer program product of claim 9, wherein generating the job-specific attributes profile for the job includes incorporating a workforce sciences input, wherein the workforce sciences input is an industrial or organizational psychology recommendation or a data and behavioral science recommendation.

11. The computer program product of claim 9, wherein the program instructions executable by the processor further cause the processor to create a job-specific attributes database having a plurality of job-specific attributes profiles, wherein each job-specific attributes profile is associated with a different job.

12. The computer program product of claim 9, wherein the program instructions executable by the processor further cause the processor to generate a job description text based on the job-specific attributes profile for the job.

13. The computer program product of claim 9, wherein the program instructions executable by the processor further cause the processor to:
identify one or more candidate-specific attributes of a job candidate using one or more interview questions; and
compare the one or more candidate-specific attributes with the job-specific attributes profile.

14. The computer program product of claim 13, wherein the program instructions executable by the processor further cause the processor to evaluate an interview question, interviewer or interview process based on the candidate-specific attributes identified in comparison to the job-specific attributes in the job-specific attributes profile.

15. The computer program product of claim 13, wherein the program instructions executable by the processor further cause the processor to generate one or more open-ended interview questions designed to obtain information from the job candidate relating to the j ob-specific attributes in the job-specific attributes profile.

16. The computer program product of claim 9, wherein the program instructions executable by the processor further cause the processor to:
analyze a reference employee to identify one or more employee-specific attributes relating to the job-specific attributes in the job-specific attributes profile; and
matching a job candidate with the reference employee based on the one or more employee-specific attributes.

17. A system for determining key professional skills and personality traits for a job comprising a skill extractor executed by the computer, wherein the skill extractor:
analyzes, on one or more computers, organization and industry data to identify one or more job-specific attributes associated with a job; and
generates, on one or more computers, a job-specific attributes profile for the job comprising the one or more identified job-specific attributes;
wherein the job-specific attributes include one or more professional skills and personality traits that positively influence an outcome of the job.

18. The system of claim 17, wherein the skill extractor further generates a job description text based on the job-specific attributes profile for the job.

19. The system of claim 17, wherein the skill extractor further:
identifies one or more candidate-specific attributes of a job candidate using one or more interview questions;
compares the one or more candidate-specific attributes with the job-specific attributes profile; and
evaluates an interview question, interviewer or interview process based on the candidate-specific attributes identified in comparison to the job-specific attributes in the job-specific attributes profile.

20. The system of claim 17, wherein the skill extractor further:
analyzes a reference employee to identify one or more employee-specific attributes relating to the job-specific attributes in the job-specific attributes profile; and
matches a job candidate with the reference employee based on the one or more employee-specific attributes.
